(19) United States
(12) Patent Application Publication
(10) Pub. No.: US 2012/0050534 A1
(43) Pub. Date: Mar. 1, 2012

(54) VEHICLE VIDEO SYSTEM AND VIDEO CAMERA THEREFOR

(75) Inventor: Tsutomu TOTANI, Aichi (JP)

(73) Assignee: Beat-Sonic Co., Ltd., Nisshin-shi (JP)

(21) Appl. No.: 12/904,278

(22) Filed: Oct. 14, 2010

(30) Foreign Application Priority Data
Aug. 24, 2010 (JP) 2010-186890

(51) Int. Cl. H04N 7/18

(52) U.S. Cl. 348/148; 348/E07.085

(57) ABSTRACT

A vehicle video system includes a video camera installed on an exterior surface of vehicle body to image a front or rear view field in front of or behind the vehicle and a monitor display located near a driver's seat in a passenger compartment to display an image of front or rear view field obtained by the video camera. The video camera is disposed on an upper end middle of front or rear window glass or on a part of roof panel near upper end middle of front or rear window glass, and the video camera images an upper surface of vehicle body inclusive of right and left corners of vehicle body front together with the front or rear view field so that the monitor display displays an image of front view field together with an image of upper surface of vehicle body inclusive of front corners of vehicle body.

### CROSS-REFERENCE TO RELATED APPLICATIONS

This application is based upon and claims the benefit of priority from the prior Japanese Patent Application No. 2010-186890, filed on Aug. 24, 2010, the entire contents of which are incorporated herein by reference.

### BACKGROUND

1. Technical Field

The present disclosure relates to a vehicle video system including a video camera which is installed on an exterior surface of vehicle body to image a front view field in front of a vehicle and a rear view field behind the vehicle and which delivers an obtained image to a monitor display installed near a driver's seat in a passenger compartment so that the image is displayed on the monitor display, and a video camera for use in the vehicle video system.

2. Related Art

A video camera is installed on a front end of the vehicle body or a front bumper to image a front view field in front of the vehicle in the above-described vehicle video system. Furthermore, a video camera is also installed on a rear end of the vehicle or a rear bumper to image a rear view field behind the vehicle. Japanese Patent Application Publication JP-A-2010-166196 discloses one of the aforementioned vehicle video systems.

No image of the vehicle body is displayed or a mere slight part of the bumper is displayed in the above-described video camera system provided with the video camera installed on the front or rear end or the front or rear bumper. More specifically, when a vehicle is parked in a predetermined space such as a garage, almost no part of the vehicle body is displayed on a monitor display although an obstacle such as a wall located in front of or behind the vehicle or a white line defining a parking space is displayed on the monitor display. Accordingly, the driver cannot sensuously get a distance between the vehicle body and the obstacle or the white line and the size of the vehicle body even when viewing the image on the monitor display. For this reason, the driver needs to visually look before and after the vehicle carefully.

### SUMMARY

Therefore, an object of the present disclosure is to provide a vehicle video system which can give the driver sensuous obtainment of a distance between the vehicle body and an obstacle or a white line defining a parking space and the size of the vehicle body even when the driver views the image on the monitor display, and a video camera therefor.

The present disclosure provides a vehicle video system including a video camera which is installed on an exterior surface of a vehicle body to image a front view field in front of the vehicle and a monitor display which is provided near a driver's seat in a passenger compartment to display an image of the front view field obtained by the video camera. The video camera is disposed on an upper end middle of a front window glass or on a part of a roof panel located near the upper end middle of the front window glass. The video camera images an upper surface of the vehicle body inclusive of right and left corners of a front of the vehicle body together with the front view field so that the monitor display displays an image of the front view field together with an image of the upper surface of the vehicle body inclusive of the right and left corners of the front of the vehicle body.

### BRIEF DESCRIPTION OF THE DRAWINGS

In the accompanying drawings:

FIG. 1 is a side view of a vehicle provided with a vehicle video system according to a first embodiment;

FIG. 2 is a perspective view of the vehicle as viewed from obliquely behind;

FIG. 3 is a perspective view of a video camera equipped on the vehicle as viewed from obliquely above;

FIG. 4 is a side view of the video camera;

FIG. 5 shows the video camera secured to a rear window glass;

FIG. 6 shows a screen of monitor display displaying rear view field;

FIG. 7 shows a screen of monitor display displaying front view field; and

FIG. 8 is a partially broken side view of the video camera of the vehicle video system according to a second embodiment.

### DETAILED DESCRIPTION

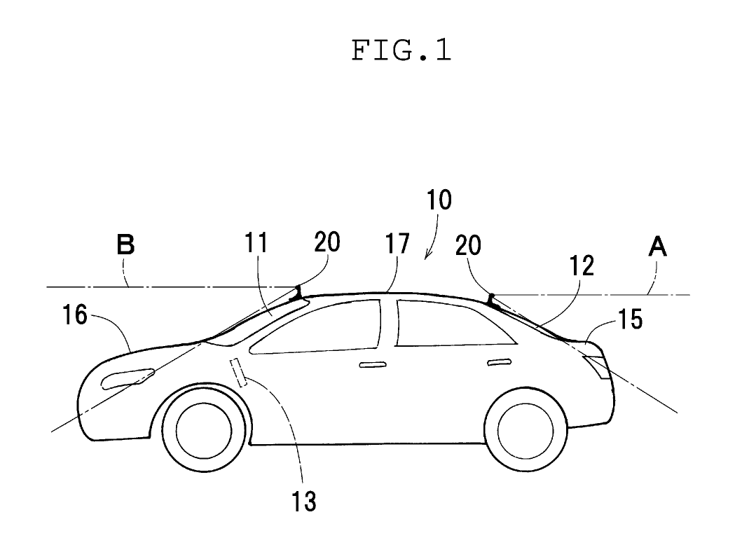

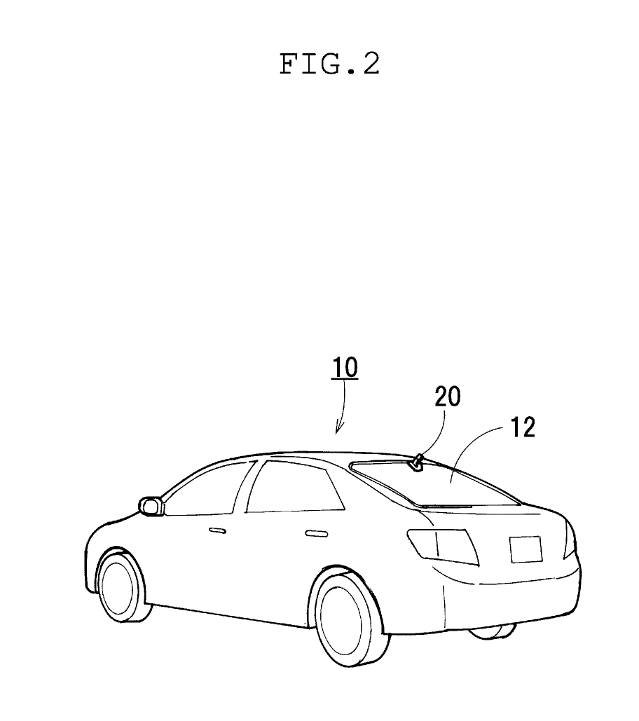

A first embodiment will be described with reference to FIGS. 1 to 7. Referring to FIGS. 1 and 2, a vehicle 10 such as an automobile is shown which is equipped with a vehicle video system according to the first embodiment and a video camera for the vehicle video system. The vehicle 10 includes a front window glass 11 having an upper end middle and a rear window glass 12 having an upper end middle. Two video cameras 20 are installed on the upper end middles of the front and rear window glasses 11 and 12 respectively. A monitor display 13 is disposed near a driver's seat in a passenger compartment. An image obtained by either video camera 11 or 12 is supplied to the monitor display 13 so that the image is displayed on the monitor display 13.

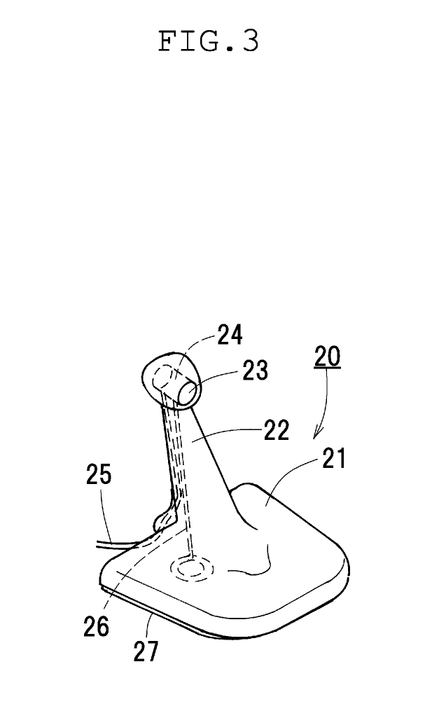

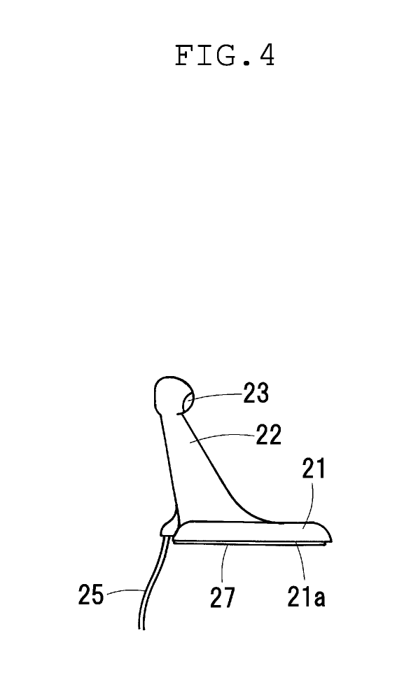

The video camera 20 includes a base 21 which is substantially rectangular in a planar shape and a tapered support pillar 22 standing on the base 21, as shown in FIGS. 3 and 4. The support pillar 22 has a distal end into which is incorporated a camera head 24 comprising an imaging device and a single-focus imaging lens 23. A camera cord 25 extends out of a lower end of the support pillar 22 to connect the camera head 24 and the monitor display 13.

The base 21 and the support pillar 22 are formed integrally with each other from a nonrigid plastic such as gum resin. A bendable metal mandrel 26 is buried in the support pillar 22 to connect the camera head 24 and the base 21. The base 21 has an underside 21a which is formed so as to be flat. A double-faced tape 27 is stuck to the underside 21a.

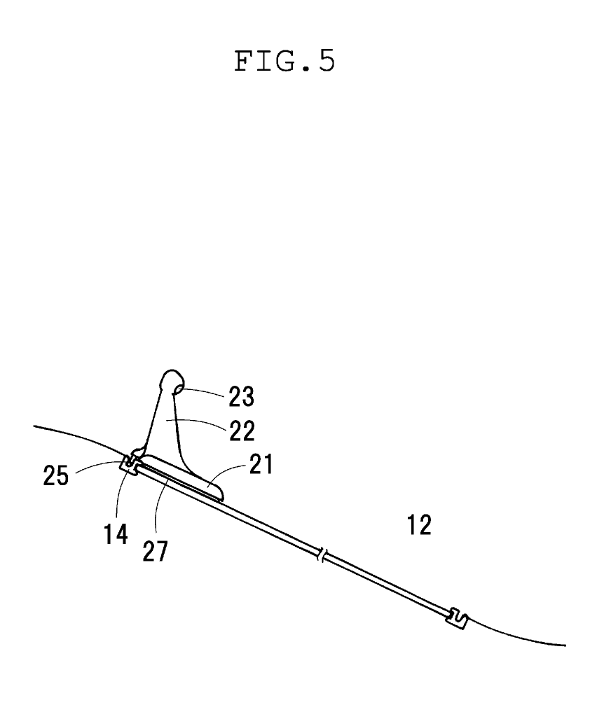

The double-faced tape 27 is then stuck onto a rear window glass 12 so that the video camera 20 is fixed to the rear window glass 12, as shown in FIG. 5. Since the base 21 of the video camera 20 is made of the nonrigid plastic and the underside 21a of the base 21 is formed so as to be flat, the tape 27 can be attached firmly to the window glass 12 even when the window glass 12 is curved. The camera cord 25 extends along a groove of a weather strip 14 of the rear window to be connected to the monitor display 13 in the passenger compartment.

The support pillar 22 of the video camera 20 is made of the nonrigid plastic, and the mandrel 26 is made of a bendable material. Accordingly, after the video camera 20 has been bonded and fixed to the rear window glass 12, the support pillar 22 is bent in the front-rear direction or in the right-left direction so that an imaging field angle A of the video camera 20 is adjusted.

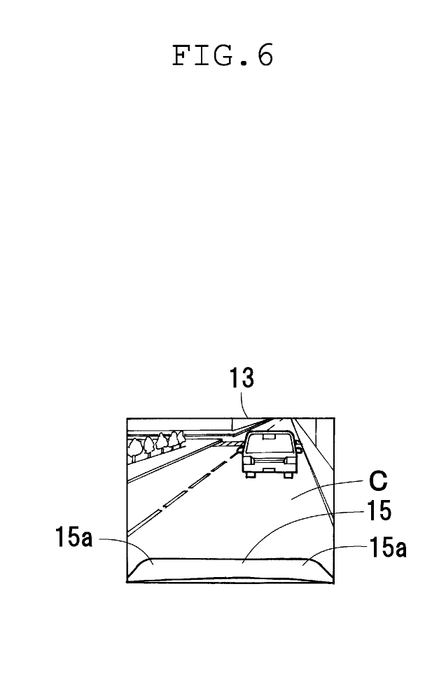

The imaging field angle A of the video camera 20 is adjusted so that a rear view field C of the vehicle 10 is displayed on the monitor display 13 and so that an upper surface of a trunk 15 which is a rear part of the vehicle 10 is displayed together with right and left corners 15a of the trunk 15, as shown in FIG. 6. In the embodiment, the field angle A is adjusted so that an image scope of the trunk 15 occupies substantially one third of the screen of the monitor display 13.

Another video camera 20 is also bonded and fixed to a front window glass 11 in the same manner as the rear window glass 12. An imaging field angle B of the video camera 20 is adjusted so that a front view field D of the vehicle 10 is displayed on the monitor display 13 and so that an upper surface of a hood or bonnet 16 which is a front part of the vehicle 10 is displayed together with right and left corners 16a of the hood 16. In the embodiment, the field angle B is adjusted so that an image scope of the hood 16 occupies substantially one third of the screen of the monitor display 13.

According to the above-described vehicle video system, the image of the upper surface of the hood 16 inclusive of the right and left corners is displayed on the monitor display 13 together with the image of the front view field D, or the image of the upper surface of the trunk 15 inclusive of the right and left corners is displayed on the monitor display 14 together with the image of the rear view field C. Accordingly, the driver can sensuously get a distance between the vehicle body and an obstacle or a white line defining a parking space and the size of the vehicle body while viewing the image on the monitor display. Consequently, the driver can put his/her vehicle into the garage or turn into a parking space more easily. Additionally, a selector switch (not shown) is provided for selecting the front or rear view field to be displayed on the monitor display 13.

The video camera 20 can be installed on existing vehicles since the video camera 20 is bonded onto the window glass 11 or 12 to be fixed in position. In particular, the underside 21a of the video camera 20 is made of the nonrigid plastic. As a result, the video camera 20 can be bonded closely to the window glass 11 or 12 more easily.

Furthermore, the direction of the camera head 24 can be adjusted in the up-down direction and in the right-left direction so that the image of the upper surface of the hood 16 inclusive of the right and left corners is displayed on the monitor display 13 together with the image of the front view field D, or so that the image of the upper surface of the trunk 15 inclusive of the right and left corners is displayed on the monitor display 14 together with the image of the rear view field C.

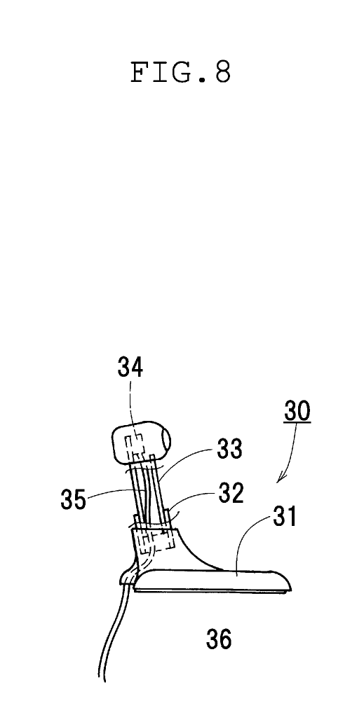

FIG. 8 illustrates a second embodiment. The video camera 30 in the second embodiment comprises a base 31 having a flat underside made of the nonrigid plastic, a first cylindrical shaft 32 standing on the base 31 and a second cylindrical shaft 33 which is inserted into the first cylindrical shaft 32 so as to be telescopically movable into and outward from the first cylindrical shaft 32. The second cylindrical shaft 33 has a distal end to which a camera head 34 is fixed. A camera cord 35 extends through the first and second cylindrical shafts 32 and 33, being drawn through a rear end of the base 31 outside the base 31. The double-faced tape 36 is affixed to the underside of the base 31.

The differences of the video camera 30 from the video camera 20 in the first embodiment have now been described above. The video cameras 30 can be bonded and fixed to the window glasses 11 and 12 of the vehicle by the double-faced tape 36 in the same manner as in the first embodiment respectively.

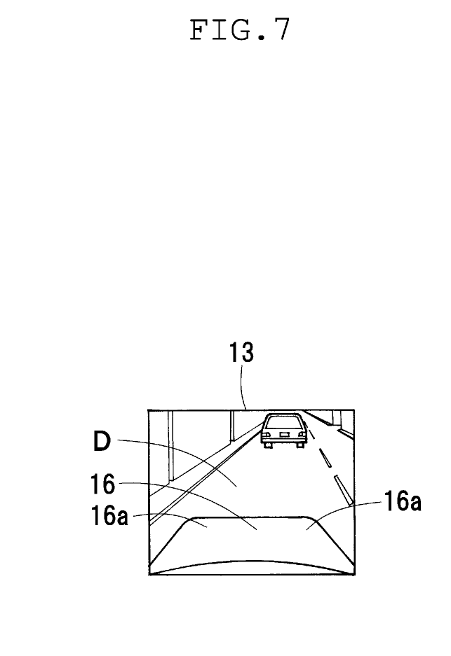

After the video camera 30 has been fixed to the window glass 11 or 12, the second cylindrical shaft 33 is telescopically moved so that the level of the camera head 34 relative to the base 31 is adjusted. Accordingly, the imaging field angle A of the video camera 30 can more easily be adjusted so that the image of the upper surface of the hood 16 inclusive of the right and left corners is displayed on the monitor display 13 together with the image of the front view field D, or the image of the upper surface of the trunk 15 inclusive of the right and left corners is displayed on the monitor display 14 together with the image of the rear view field C, in the same manner as shown in FIGS. 6 and 7.

The video cameras 20 and 30 are bonded and fixed to the upper end middles of the front or rear window glasses 11 and 12 in the foregoing first and second embodiments respectively. However, each of the video cameras 20 and 30 may be installed on a part of a roof panel 17 located near the upper end middle of the front or rear view window glass 11 or 12. In this case, the video camera 20 or 30 may be bonded to or fixed to the roof panel 17 by small screws or the like.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A vehicle video system including a video camera which is installed on an exterior surface of a vehicle body to image a front view field in front of the vehicle and a monitor display which is provided near a driver's seat in a passenger compartment to display an image of the front view field obtained by the video camera, wherein:
the video camera is disposed on an upper end middle of a front window glass or on a part of a roof panel located near the upper end middle of the front window glass; and
the video camera images an upper surface of the vehicle body inclusive of right and left corners of a front of the vehicle body together with the front view field so that the monitor display displays an image of the front view field together with an image of the upper surface of the vehicle body inclusive of the right and left corners of the front of the vehicle body.

2. A vehicle video system including a video camera which is installed on an exterior surface of a vehicle body to image a rear view field in front of the vehicle and a monitor display which is provided near a driver's seat in a passenger compartment to display an image of the rear view field obtained by the video camera, wherein:
the video camera is disposed on an upper end middle of a rear window glass or on a part of a roof panel located near the upper end middle of the rear window glass; and
the video camera images an upper surface of the vehicle body inclusive of right and left corners of a rear of the vehicle body together with the rear view field so that the monitor display displays an image of the rear view field together with an image of the upper surface of the vehicle body inclusive of the right and left corners of the rear of the vehicle body.

3. The system according to claim 1, wherein the video camera has a base formed with a flat bottom which is bonded to the front window glass or the roof panel thereby to be fixed in position.

4. The system according to claim 2, wherein the video camera has a base formed with a flat bottom which is bonded to the rear window glass or the roof panel thereby to be fixed in position.

5. The system according to claim 3, wherein the bottom of the base is made of a nonrigid plastic.

6. The system according to claim 4, wherein the bottom of the base is made of a nonrigid plastic.

7. The system according to claim 1, wherein the base includes a bendable support pillar standing thereon, the support pillar having a distal end on which a camera head is provided, and the base is bonded to the front window glass or the roof panel and the support pillar is bent so that the camera head is adjustable in an up-down direction and a right-left direction.

8. The system according to claim 2, wherein the base includes a bendable support pillar standing thereon, the support pillar having a distal end on which a camera head is provided, and the base is bonded to the rear window glass or the roof panel and the support pillar is bent so that the camera head is adjustable in an up-down direction and a right-left direction.

9. The system according to claim 3, wherein the base includes a bendable support pillar standing thereon, the support pillar having a distal end on which a camera head is provided, and the base is bonded to the front window glass or the roof panel and the support pillar is bent so that the camera head is adjustable in an up-down direction and a right-left direction.

10. The system according to claim 4, wherein the base includes a bendable support pillar standing thereon, the support pillar having a distal end on which a camera head is provided, and the base is bonded to the rear window glass or the roof panel and the support pillar is bent so that the camera head is adjustable in an up-down direction and a right-left direction.

11. The system according to claim 5, wherein the base includes a bendable support pillar standing thereon, the support pillar having a distal end on which a camera head is provided, and the base is bonded to the front window glass or the roof panel and the support pillar is bent so that the camera head is adjustable in an up-down direction and a right-left direction.

12. The system according to claim 6, wherein the base includes a bendable support pillar standing thereon, the support pillar having a distal end on which a camera head is provided, and the base is bonded to the rear window glass or the roof panel and the support pillar is bent so that the camera head is adjustable in an up-down direction and a right-left direction.

13. The system according to claim 1, wherein the base includes a telescopic support pillar standing thereon, the support pillar having a distal end on which a camera head is provided, and the base is bonded to the front window glass or the roof panel and the support pillar is telescopically moved so that a level of the camera head relative to the base is adjustable.

14. The system according to claim 2, wherein the base includes a telescopic support pillar standing thereon, the support pillar having a distal end on which a camera head is provided, and the base is bonded to the rear window glass or the roof panel and the support pillar is telescopically moved so that a level of the camera head relative to the base is adjustable.

15. The system according to claim 3, wherein the base includes a telescopic support pillar standing thereon, the support pillar having a distal end on which a camera head is provided, and the base is bonded to the front window glass or the roof panel and the support pillar is telescopically moved so that a level of the camera head relative to the base is adjustable.

16. The system according to claim 4, wherein the base includes a telescopic support pillar standing thereon, the support pillar having a distal end on which a camera head is provided, and the base is bonded to the rear window glass or the roof panel and the support pillar is telescopically moved so that a level of the camera head relative to the base is adjustable.

17. The system according to claim 5, wherein the base includes a telescopic support pillar standing thereon, the support pillar having a distal end on which a camera head is provided, and the base is bonded to the front window glass or the roof panel and the support pillar is telescopically moved so that a level of the camera head relative to the base is adjustable.

18. The system according to claim 6, wherein the base includes a telescopic support pillar standing thereon, the support pillar having a distal end on which a camera head is provided, and the base is bonded to the rear window glass or the roof panel and the support pillar is telescopically moved so that a level of the camera head relative to the base is adjustable.

19. A video camera for a vehicle video system, which is installed on an exterior surface of a vehicle body to image a front or rear view field in front of or behind the vehicle and a monitor display which is provided near a driver's seat in a passenger compartment to display an image of the front or rear view field obtained by the video camera, wherein:
the video camera has a base formed with a flat underside which is bonded to the front or rear window glass or the roof panel thereby to be fixed in position.

20. The video camera according to claim 19, wherein the underside of the base is made of a nonrigid plastic.
